(19) United States
(12) Patent Application Publication
(10) Pub. No.: US 2010/0161491 A1
(43) Pub. Date: Jun. 24, 2010

(54) VEHICLE FED ACCIDENT REPORT

(75) Inventors: Frederic Bauchot, Saint-Laurent-Du-Var (FR); Gerard Marmigere, Drap (FR); Carole Truntschka, Saint-Laurent-Du-Var (FR); Florence Tressols, Saint-Laurent-Du-Var (FR)

Correspondence Address: Scully, Scott, Murphy & Presser, P.C., 400 Garden City Plaza, Suite 300, Garden City, NY, 11530, US

(73) Assignee: INTERNATIONAL BUSINESS MACHINES CORPORATION, Armonk, NY (US)

(21) Appl. No.: 12/561,851

(22) Filed: Sep. 17, 2009

(30) Foreign Application Priority Data
Dec. 19, 2008 (EP) 08305989

(51) Int. Cl. G06Q 40/00; H04L 9/32

(52) U.S. Cl. 705/50; 705/4; 713/156

(57) ABSTRACT

A computer implemented method for rapidly and securely filing, via wireless means, a consolidated accident report. An additional aspect of the method encompasses a computer software product for performing the method described herein. In one embodiment of the invention, the opposing parties jointly fill out at least a part of a digital accident report form; i.e., each party fills out a different portion of the form. Each party has the opportunity to positively acknowledge or reject the information entered by their opposing party. The digital accident report form may be completed and filed with the rejection registered, although it is preferred that a mutually agreeable resolution be achieved. Once completed, each opposing party files the consolidated accident report with an appropriate interested third party, e.g., an insurance company, a law enforcement agency, or a hospital.

### FIELD OF THE INVENTION

The invention relates generally to the preparation and transmission of accident-related reports or forms of confidential information relating to an accident via secure wireless transmission to one or more interested third parties.

### BACKGROUND OF THE INVENTION

Many insurance companies as well as the administrative arms of various state and municipal agencies require standardized forms to be used to declare facts and circumstances of a vehicular accident. If you are involved in an auto accident, you are expected to promptly report it to your insurance company, as well as to the local police department, and if the amount of damage caused in the accident is over a certain value, e.g., more than approximately $1,000, or if a person sustains any physical injury the filing of a report is mandatory. The accident report is usually provided by entering information in a form, thereby rendering the processing of the report more efficient.

Typically an accident report form is composed of two or more parts to be filled out by participants, i.e., the opposing parties of such an accident. Such forms usually require information regarding each party, e.g., name, address, insurance information, and the like; extent of damage to vehicle and person; conditions of road, weather, time of day, and even diagrams and narratives of the party's recollection of the accident. In addition there may be included various types of questions having checkboxes, yes/no or multiple choice response categories.

A drawback of the current system of filing accident reports is founded in that most vehicle operators do not routinely carry accident report forms with them. Thus, few accident reports can be filled out and filed at the site of the accident and/or with the cooperation of additional opposing parties. As the time period between the accident and the filing of the accident report increases there is a greater likelihood of information entered into the report as being less accurate. This in turn may contribute to the contentiousness between parties and insurance companies, and perhaps between the opposing parties themselves.

Therefore, there is a need in art to provide a system by which opposing parties to a vehicular accident may fill out accident reports soon after the occurrence of the accident, and even to file them from the site of the accident where the recollections and perceptions of the underlying events are fresh within the minds of opposing parties, witnesses, police and medical personnel, and the like.

### SUMMARY OF THE INVENTION

It is therefore an object of the present invention to provide a system by which vehicle operators, opposing parties to an accident, witnesses, medical and law enforcement personnel and others, may file or even co-prepare, an accident report and immediately file it with the appropriate interested third party, e.g., an insurance company, a police station or hospital and the like. It is a further object to provide a wireless telecommunications system for downloading, filling out and transmitting the forms to a relevant party for review and even editing.

In one embodiment, the method comprises a series of computer implemented steps provided by a computer program product implemented by, for example wireless means. Each opposing party thereby participates in the process, ideally, with an agreeable and amicable intent to prepare a consolidated accident report, and to transmit the accident report to each party's insurance company, and/or another interested third party. Therefore, one embodiment of the process comprises the following aspects:
a. Each opposing party filling out his/her own digital accident report form using an input unit and a display operably linked to a mobile wireless device, e.g., a mobile phone, PDA (personal digital assistant) and other similar handheld devices, car computers, and the like;
b. Each opposing party enters his/her own vehicle information in a digital accident report form, which optionally, may be retrieved from the vehicle using short range wireless communication means such as, Bluetooth, NFC (Near Field Communication), IRDR (infrared data reduction), WiFi (Wireless Fidelity; the 802.11b wireless Ethernet standard). It should be noted that the vehicle information may include data reflecting one or more of the vehicle operating conditions, mechanical failures or lack thereof, as well as vehicle local geographic information, weather, visibility, and the like. It should also be apparent that the nature of the information, as well as its mode of retrieval may vary from one vehicle type to another.
c. Each digital accident report form having its personal vehicle information and additional optional information (e.g., a diagram of the accident; a narrative of the facts, and the like) is digitally signed by each party, and the signed digital accident report form is then transmitted via a wireless device to the opposing party for its digital signature. The exchanging of each party's digitally signed form with their opposing party preferably is achieved via a short range transmission means. The opposing party's participation, e.g., signing the other party's digital accident report form provides an opportunity for the opposing party to either (i) positively acknowledge, i.e., approve, the information supplied; or (ii) to register an objection to, i.e., to reject, some aspect of the opposing party's data and information.
d. The rejection preferably comprises at least one non-approving, rebutting or alternative explanation, comment, diagram, and the like. In another embodiment, an opposing party may indicate their rejection of the opposing party's information by appropriately marking a checkbox, or selecting a drop down menu selection.
d. The approval by an opposing party is preferably acknowledged by an opposing party entering its global signature. The global signature is an encrypted message digest of all of the entered data. Other less secure forms of achieving approval may be used, such as a checkbox and/or a drop down menu.
e. Each opposing party sends their complete statement of the accident to its own insurance company (after optionally, entering additional information such as map position, where the accident occurred, photos of the vehicle after the accident, or the scene of the accident, or video, audio and other comments); and,
f. Each insurance company optionally verifies the digital certificate of its client/subscriber as well as the subscriber's opposing party. In one preferred embodiment, the certificate verification is obtained at a trusted party's server.
g. Optionally, sending to the subscribing party from the insurance company a statement of acknowledgment of the party's report and claim.

The statement of acknowledgment by a party's insurance company may provide additional information such as either of a party's rate of responsibility, which is a determination of each party's fault for the accident. Each party's rate of responsibility may reflect the eventual percent of damages that each party will incur. For example, if Party A is 100% responsible, then Party B is 0% responsible, and all damages will be paid for by Party A and/or Party A's insurance company.

It is further contemplated that the wireless communication system will download the information form, preferably in a fillable condition, which means opening the form and filling it in via the computer while the downloaded form is visible on the display of a wireless device. Thus, it is an even further object of the invention to provide a system and method that can be employed with virtually any wireless communication device that has an input unit operably linked thereto.

The present invention further encompasses the use of one or more standardized electronic report formats that are suitable for streamlining accident report administration procedures. The proposed forms, whether a report, form and/or a signed accident report of facts, may be securely transmitted, digitally signed by a party, and authenticated upon receipt by an intended recipient. In one embodiment forms are preloaded in the mobile wireless device and can be permanently stored and downloaded at any time. In an alternative embodiment, the form can be downloaded from a server that is maintained by a law enforcement agency, an insurance company, or a hospital or other medical care provider.

When an accident occurs or preferably soon, or even immediately after, each opposing party fills out their respective forms using either a motor vehicle's wireless computer or mobile device, or any wireless communication device suitable for mobile use. Thereafter, each party exchanges and reviews the other's form, the last party reviewing the report adds a global signature indicating that the entirety of the report up to that point in time has been read and ideally, agreed to by both parties. The retrieval of forms and subsequent consolidation into a completed accident report may be achieved by short range communication means, such as Bluetooth, NFC, IrDr, Wifi, and the like. The exchange of information between opposing parties, e.g., reviewing each form, may also be achieved by such short range communication means. Each opposing party may then submit the consolidated report to interested third parties, e.g., insurance company servers, traffic control units, law enforcement units and the like via long range wireless communication means such as the internet or a wireless facsimile.

The foregoing method is a computer implemented method for securely providing at least one interested third party with a consolidated accident report at a scene of a vehicular accident, the consolidated accident report comprising one or more forms filled in by a first opposing party, Party A, and a second opposing party, Party B, to said vehicular accident, comprising, a method for securely providing at least one interested third party with a consolidated accident report at a scene of a vehicular accident comprising a computer implemented method for preparing and filing a consolidated accident report from a scene of a vehicular accident, wherein the consolidated accident report is jointly prepared by one or more parties to the accident, the method comprising:

providing one or more digital accident report forms to one or more parties to a vehicular accident wherein each of the one or more parties enters their respective personal information, vehicle information, encrypted signature, user certificate, and optionally, diagrams and/or text relating to the accident;

exchanging the completed digital accident report forms via a wireless communication between opposing parties, and each party either positively acknowledging the opposing party's information or rejecting said information by entering into said form an indication of said acknowledging or said rejecting;

entering each party's global signature to the opposing party's completed digital form;

generating a consolidated accident report comprising one or more digital accident report forms filled in by each opposing party;

and transmitting the consolidated accident report to an interested third party's server device via a wireless communication,

wherein the wireless communication is transmitted via a handheld wireless communication device or an on-board vehicle wireless communication device.

An additional aspect of the invention is directed to a computer program product for filling out an digital accident report and transmitting the consolidated accident report to at least one interested third party, the computer program product comprising a computer usable medium having computer usable program code embodied therewith, the computer usable program code comprising:

computer usable program code configured for providing one or more digital accident report forms to one or more parties to a vehicular accident wherein each of the one or more parties enters into the one or more digital accident report forms their respective personal information, vehicle information, encrypted signature, user certificate, and optionally, diagrams and/or text relating to the accident

computer usable program code configured for exchanging the completed digital accident report forms via a wireless communication between opposing parties, and each party either positively acknowledging the opposing party's information or rejecting said information by entering into said form an indication of said acknowledging or said rejecting;

a computer usable program code configured for entering each party's global signature to the opposing party's completed digital form;

a computer usable program code configured for generating a consolidated accident report comprising one or more digital accident report forms filled in by each opposing party; and,

a computer usable program code configured for transmitting the consolidated accident report to an interested third party's server device via a wireless communication,

wherein the wireless communication is transmitted via a handheld wireless communication device or an on-board vehicle wireless communication device.

### BRIEF DESCRIPTION OF THE DRAWINGS

The following drawings are for illustrative purposes and are not meant to limit the scope of the embodiments of the methods and systems encompassed by the present invention.

FIG. 1 shows the system infrastructure by which two opposing parties, Party A and Party B, directly communicate with each other as well as with their respective insurance companies' servers (or other interested third parties) and their vehicle computer systems.

FIG. 2 depicts an illustrated embodiment of the process flow for creating and sending an electronic accident report that is jointly prepared by the opposing parties to a vehicular accident.

FIG. 3 depicts an illustrated embodiment of the process flow for creating and sending an electronic accident report wherein the opposing parties perform additional negotiating and rejecting steps, when necessary.

FIG. 4 depicts an illustrated embodiment of the process flow for creating and sending an electronic accident report to an interested third party (insurance company, medical care giver, law enforcement agency and the like), wherein the accident report further includes information supplied by a witness.

FIG. 5(a)-(c) provides a non-limiting example of the component parts, or forms that when combined, comprise an accident report; (a) exemplifies a basic embodiment of a form provided by party A; (b) is an example of the form of (a) combined with opposing party B's form wherein party B provides a global signature indicating acceptance or agreement with the information present in both forms; (c) provides an example wherein the form of party A is combined with a form of opposing party B wherein rather than including the global signature party B includes a cause for rejecting or objecting to all or part of the information included in the combined forms.

FIG. 6 illustrates examples of the completed consolidated accident reports that are transmitted by a wireless device to an interested third party.

### DETAILED DESCRIPTION OF THE INVENTION

In the context of the present invention, the term “vehicle” refers to any device suitable to transport one or more individuals. Therefore, any wireless communication and computer system and methods of use thereof are not limited to motorized vehicles but encompass virtually any mode of transportation whether or not it may be associated with industrial, social or recreational activity. Therefore, in addition to any automobile, bus, train or truck and the like, and motorized boats, motor cycles and scooters, the present invention also encompasses bicycles, tricycles, sail boats, row boats, canoes and kayaks, aircraft including gliders and the like.

A “party to an accident is one that operates the vehicle or is being transported therein, or someone that suffers direct harm from the accident. In the context of the present invention, the term “opposing party” encompasses any party to the accident that may seek benefits from an insurance company or that may become adversaries in a legal proceeding. For the purpose of the illustrative examples and description provide, the term opposing parties will refer to the person operating the vehicles involved in the accident. However it should be apparent that the concept of opposing parties also encompasses passengers or pedestrians that are involved or injured as a result of the accident.

Reference to one or more “interested third parties” encompasses virtually any agency, organization, business or individual that may have an interest in, or responsibility to react to, the accident. Most commonly, an interested third party would likely be an insurance company, a hospital or other form of medical care provider, a law enforcement agency, a bridge and/or tunnel maintenance authority, and the like.

The “consolidated accident report” or “accident report” is the completed or nearly completed accident report that is wirelessly transmitted to an interested third party (hospital, insurance company, police/law enforcement, and the like). As described below, the consolidated report is an assembly of smaller forms or forms that are downloaded from the wireless device and filled out using the input unit of the wireless device. Some forms form mandatory portions of the consolidated report whereas others are optional. The mandatory forms include each party's personal information, vehicle identification, vehicle performance information and digital signatures. Optional sub- reports may include witness testimony, diagrams/photos, recitation of events, and the like. It should be apparent to persons of ordinary skill in the art that the classification of forms into either mandatory or optional can vary between the types of vehicles, accidents, circumstances, parties involved, and the like.

The scope of wireless mobile devices suitable for use in the present invention is very broad. Thus, a “wireless device” or a “mobile device” may be a smartphone, a handheld PDA, a portable media player, a portable e-book reader, a personal digital assistant/enterprise digital assistant, a Blackberry, ultra mobile PC, tablet PC, notebook computer, subnotebook (Netbook), portable/mobile data terminal, electronic organizer, pocket computer, handheld game consoles, carputers and the like.

As referred to in the description of the invention, the user certificates for Party A and Party B are digital certificates that act as an electronic credential and verifies that the party being presented is truly who he or she claims to be. The digital certificate contains a unique number for identification purposes, and is issued by a recognizable issuing authority that verifies the credential as authentic. In the case of a certificate, a Certificate Authority functions as the trusted, third party that issues the certificate and verifies it as an authentic credential. For authentication purposes, digital certificates make use of a public key and a related private key. The issuing CA binds these keys, along with other information about the certificate owner, to the certificate itself for identification purposes.

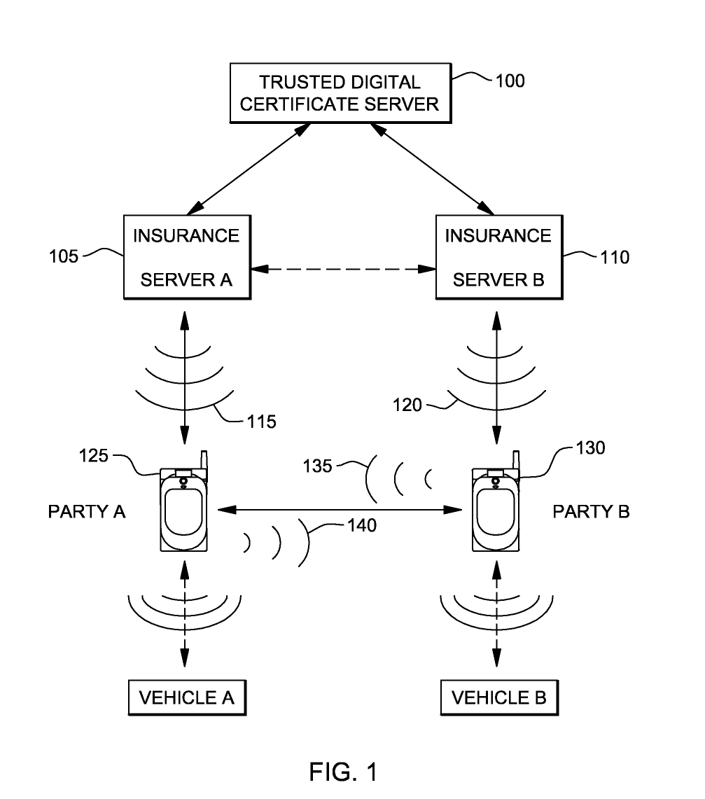

FIG. 1 illustrates the system infrastructure in which two opposing parties, for example party A and party B can directly communicate with each other, their respective vehicle computer systems, and the servers of their respective insurance companies or other interested third parties. Preparing and transmitting the consolidated accident report is contemplated to be achieved via wireless mobile communication devices 125, 130 associated with each party A, B, respectively. The mobile devices are equipped with short range communication means to allow any party to enter information, data or graphics into a form and, when possible or necessary, to download vehicle-specific information, e.g., vehicle operational parameters that were recorded before the accident. In addition, the mobile communication devices must also be able to communicate with a server associated, for example, with and insurance company, e.g., an insurance server 105,110 either using a standalone means GSM, GPRS/EDGE, UMTS, and the like, or connected to a PC either by a short range wireless communication means (e.g., Bluetooth, NFC, IrDr, Wifi) or by a wired connection (e.g., USB, serial link, Ethernet). The insurance server may also authenticate either party by validating their respective digital certificates by checking with trusted party, e.g., Trusted Digital Certificate Server 100 or issuing authority.

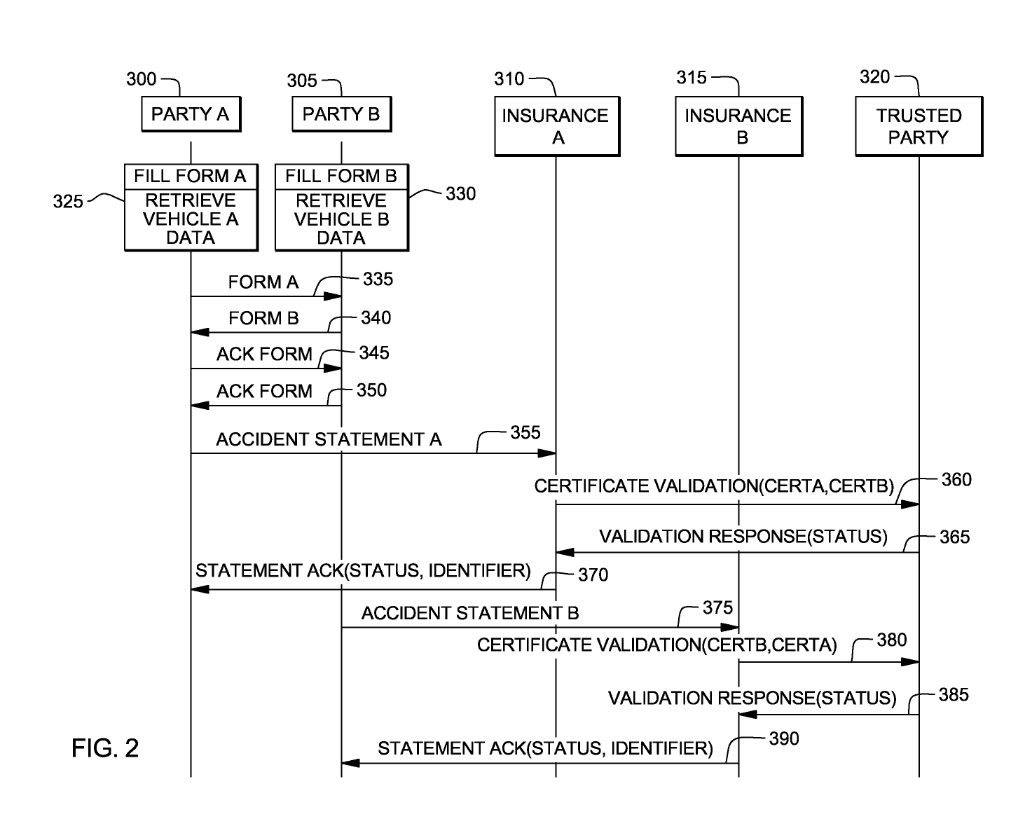

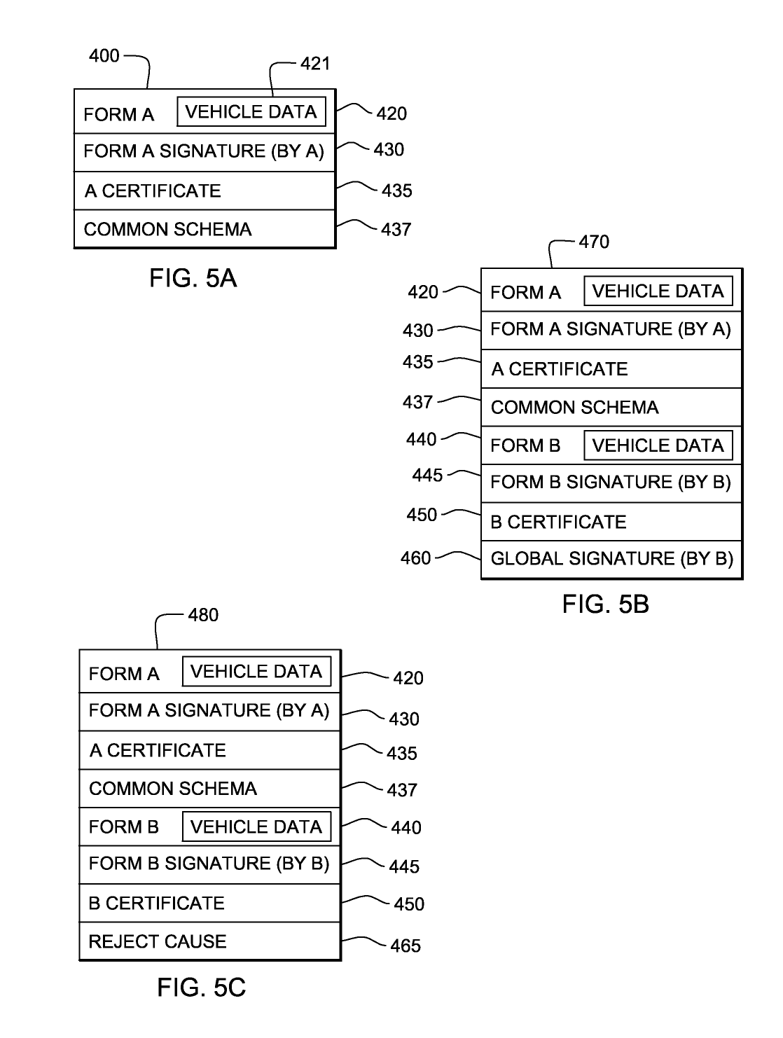

FIG. 2 depicts an illustrated embodiment of the process flow for creating and sending an electronic accident report, i.e., a consolidated accident report, which is jointly prepared by the opposing parties to a vehicular accident. The method illustrated for transmitting a wireless accident report of a vehicular accident, comprises more than one step for each opposing party. Party A and Party B begin the process by filling in form A 325 or form B 330, respectively. For each party, the initial information to be entered is the party's basic personal information, such as name, surname, address, telephone number, insurance reference (i.e., an unique numerical or alphanumerical identifier of a party's insurance company) and subscriber number (i.e., an unique numerical or alphanumerical identifier of an insurance company's client, policy holder, subscriber, and the like), in addition to the party's operator license number; or vehicle license plate and registration when applicable. This basic information may be pre-configured in the mobile communication device, e.g., as a stored template, to permit a party to automatically download and fill the form concomitantly. One embodiment of a downloaded form at an early stage of being filled out is illustrated in FIG. 5(a).

The aforementioned form A or form B may further comprise one or more check-boxes for positively or negatively indicating an answer to a questions or the relevance of additional standard information relating to the operation of the vehicle, assuming that the vehicle is linked to a computer system. A non-limiting list of such questions or information may include, e.g., (a) Is the vehicle damaged?; (b) Is the vehicle insured?; (c) Was there personal or bodily injury to yourself or a passenger?, and the like.

In some instances, e.g., in non-motorized vehicles, a vehicular computer may not available. Therefore, in one embodiment of the process, the form can be downloaded to a hand held mobile device to allow the operator of the non-motorized vehicle to manually enter any relevant vehicle information. In instances where the vehicle possesses a computer system of its own, that computer may provide the operational data required by the forms, and print out the information on the form as it is being downloaded. Alternatively, the vehicle computer can transmit the data to a distinct wireless device such as that in which the forms are stored in memory and downloaded, e.g., a mobile handheld phone or receiver. The check-boxes and data in the forms may relate to speed, acceleration, braking, steering mechanism, gears, suspensions, and other vehicle performance parameters. This portion of the accident forms may also be typically completed, if available, by GIS (Geographic Information System), GPS position, GPS speed, and GPS acceleration.

In FIG. 2, step 335 contemplates that the form filled by Party A 300 is sent to Party B 305 using, e.g., a short range wireless connection between the opposing parties. An illustration of a form at this stage of being filled out may be seen in FIG. 5(a). At this step, the form includes the information that was described above, namely, Party A's 300 personal and vehicle information. In addition, the form comprises a field for adding the party's digital signature (FIG. 5(a), 430), which is a message digest of all the information in the form, which is then encrypted with, e.g., the RSA private key of Party A. A message digest function is an algorithm, which takes a variable-length message and produces a digital fingerprint, checksum, hash value or a message digest as the output. The output is a fixed-length hash, 128 bits for MD5 (See: “The MD5 Message-Digest Algorithm,” RFC 1321 from R. Rivest), 160 bits for SHA-1 (See “Secure Hash Algorithm 1,” RFC 3174). The effectiveness of the message digest method of encryption is manifested in that even if a single byte in the message changes, the recomputed digest will be different, thereby indicating that the message has been tampered with. If there is no tampering, the digest will remain constant. At the point where either Form A or Form B is sent to the opposing party, the form also comprises the corresponding digital signature and a digital certificate.

Step 340 relates to a scenario wherein Party B 305 will fill out its own partial Form B, step 330, and transmit it to Party A 300 in step 340 before Party A 300 completes steps 325 (filling out partial Form A) and 335 (transmitting partial Form A to party B 305 for review and signing). The Form B sent to Party A 300 in step 340 appears very much like the form in FIG. 5(a) except that the party's identifiers (name, data, insurance numbers, and the like) will be of Party B 305, not Party A 300 as actually shown.

However, if step 335 has been completed before step 340, then Party B 305 adds its information and data to partial Form A and returns it to Party A 300 in step 350. If Party B 305 does not object or disagree with any of the information in partial Form A, the form returned in step 350 is considered an acknowledgement (“Ack form” in FIG. 2) and agreement of the facts entered in partial Form A.

If step 340 precedes step 335, then Party A will add its information to partial Form B, thereby providing a statement of acknowledgement (“Ack form” in FIG. 2, step 345, i.e., agreement with Party B on the underlying facts entered in the report being sent in step 340 to Party B 305.

One embodiment of the process comprises providing a box or space for adding general comments, explanations, etc. regarding the accidents. In another embodiment there is a space for providing a simple diagram of the accident. In this diagram, either party may provide its version of the facts, e.g., layout of the road, amount of traffic and in which direction, relative positions at time of impact, road signs, road constructions or other barriers, objects, and the like. In a further embodiment, both kinds of information, written remarks as well as diagrammatic representations may be entered. This space or form field is the Common Schema shown in FIGS. 5(a)-(c) and 6(a)-(b). In a preferred embodiment, the Common Schema comprises diagrams and labeling provided by either party.

The completed partial Forms A and B are joined to form a consolidated accident report. In one embodiment, each party affixes its global signature to their opposing party's copy of the consolidated accident form that will be transmitted to the opposing party's insurance company or other interested third party. The global signature added by each party, provides evidence to the opposing party's insurance company that the party's were in agreement with respect to the data entered into the report at that time. Each of the globally signed consolidated accident reports is sent to the respective insurance company by wireless means.

FIG. 2 illustrates that upon receipt of each party's consolidated accident report, each party's insurance company 310, 315 may validate each party's digital certificate in step 360 or step 380 by contacting a trusted party, most commonly a certificate validating server. As further illustrated in step 365 and step 385, each insurer may receive from each certificate authority a validation response authenticating the identity of each party. In step 370 and step 390, the insurer acknowledges receipt of the consolidated accident report to the appropriate party, and may optionally provide administrative information, e.g., case identification number, and optionally, the estimated rates of responsibility. As indicated in FIG. 2, Party A participates in steps 355, 360, 365 and 370, whereas Party B's participates in steps 375, 380, 385 and 390.

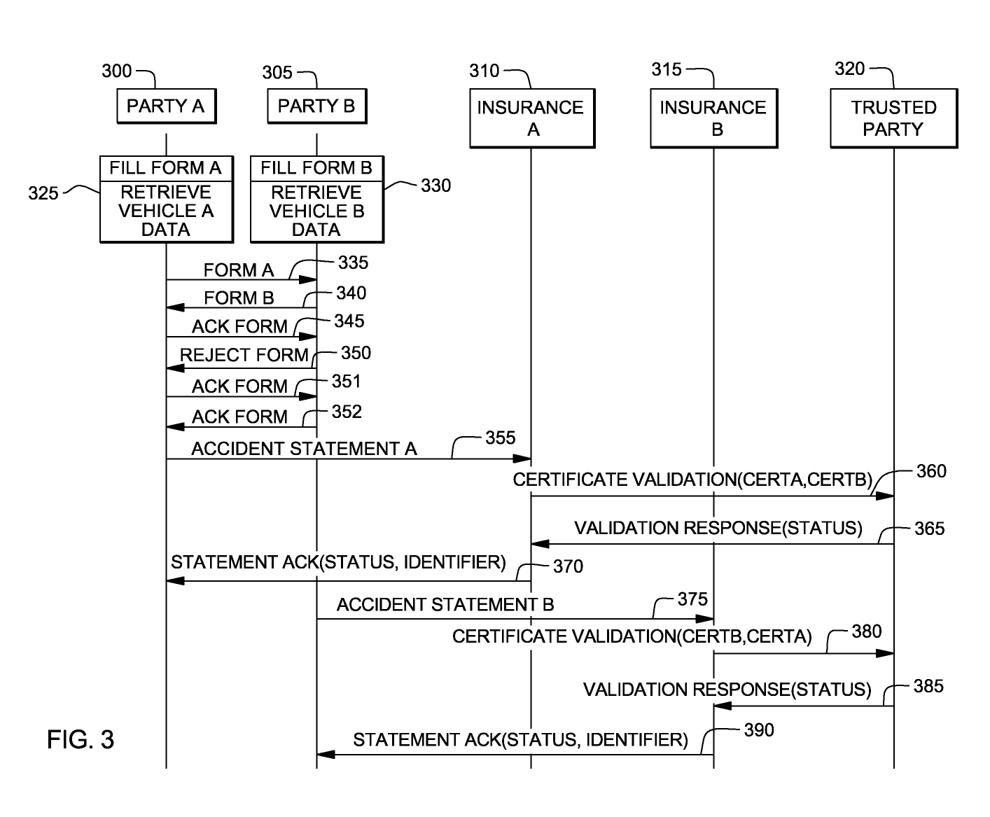

FIG. 3 illustrates an embodiment of the process similar to that shown in FIG. 2, except for modifications between step 345 and step 355, not inclusive. In response to Party A's acknowledgement of the form received from Party B, Party B sends a rejection to Party A as shown in step 350 of FIG. 3. The rejection message contain a notification of the rejection of the content of Party A's form, by adding, e.g., a code indicating a rejection, or alternatively, marking a check box for this purpose. The rejection message optionally comprises Party B's personal and vehicle data, as well as one or more modifications of the form originating with Party A. In step 351 Party A acknowledges Party B's rejection-containing consolidated form by returning the rejected consolidated form with his signature, and optionally, a response or rebuttal of the rejection in his form, i.e., his portion of the rejection-containing consolidated form) that he created himself on his own wireless mobile device. At this step either Party A's form or the entire consolidated form are signed by user A. If the consolidated form is being signed, it is referred to as the global signature. Similarly, in step 352, Party B returns party A's signed form or consolidated form with Party B's global signature.

In step 355 Party A adds some additional information to the consolidated form prepared and signed by both parties describing the accident. The additional information may be in the form of a drawing, photograph, audio and/or video recording or text. Step 355 is completed when the final consolidated accident report is transmitted to each party's own insurance company 310 or other interested third party. It is noted that steps 355 to 390 in FIG. 3 are equivalent to the identically numbered steps in FIG. 2.

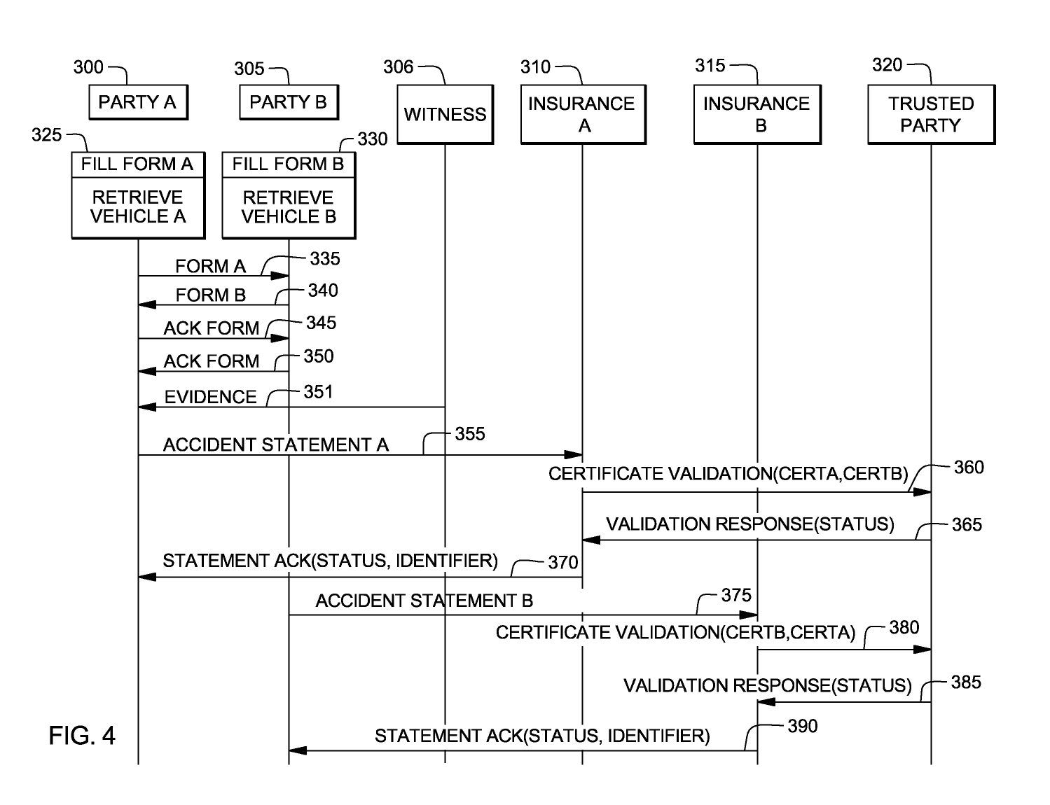

FIG. 4 illustrates an embodiment of the method wherein after acknowledgement by both parties 300, 305, i.e. steps 345 and 350, each party may add some personal complementary information as indicated by step 351. The complementary information may comprise descriptions of the accident by the party, a passenger, and/or a third party witness 306. The evidence from the witness 306 may be in the form of a narrative text and/or additional graphic, video or audio forms of recordings. This submission from the witness 306 is signed with the witness RSA private key and the witness certificate as for the opposing parties after completion of form A and form B at the accident scene.

FIG. 5(a) illustrates an embodiment of the form submitted by each party. The form comprises three mandatory fields to be completed. Mandatory personal information 420 comprises, but is not limited to, the party's name, address, telephone number, insurance reference and insurance subscriber number. Moreover one or more checkboxes may be available for selecting to define the operating status and behavior of the vehicle at accident time 421. This information may be entered by the party or directly downloaded from the vehicle's computer system. Such information includes, but is not limited to speed, acceleration, brake, trim, steering, gear, suspension, and the like. This can also be typically completed, if available, by Geographic Information System information such as GPS position, GPS speed, and GPS acceleration. The second mandatory entry comprises the party's encrypted signature 430 (i.e., Form A signature in FIG. 5(a)), which is a hashing of sub form A 400 encrypted with the RSA private key of user. The third mandatory entry is the party's authenticating certificate 435. Field 437 depicts an optional field to be used to provide a common schema of the accident.

FIG. 5(b) provides an illustrative example of Party B's positive acknowledgment 470 that is returned to Party A. See e.g., step 350 in FIG. 2. Positive acknowledgement 470 sent by the opponent, contains sub form A with fields 420, 430 and 435 completed. The common schema form field 437 is optional but enables adding further input, e.g., diagrams, narratives and the like. Further, this consolidated form or consolidated report contains form B having identical structure to form A with Party B's information 440, signature 445 and certificate 450. Also included to the consolidated form is a global signature 460, which is a hashing of the first three groups of information, encrypted with the RSA private key of the party who sent the positive acknowledgement (Party B in this illustration).

FIG. 5(c) shows a negative acknowledgment sent by party B as indicated in FIG. 3 step 350. The message structure is very similar to that of the positive acknowledgement, except that the global signature has been replaced by a rejection notice 465, e.g. the basis of the rejection.

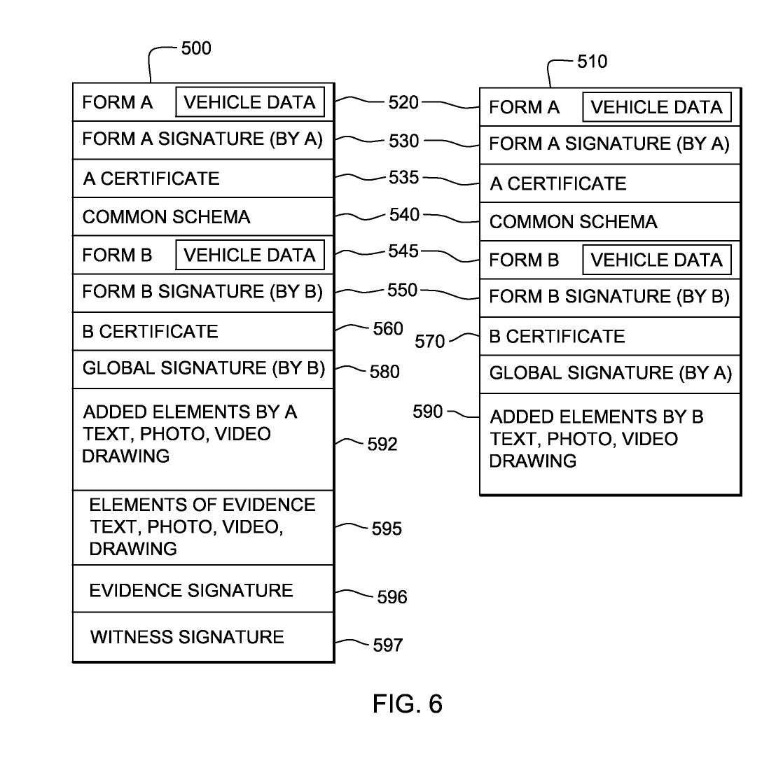

FIG. 6 shows the message structure of the completed consolidated accident report as transmitted to the insurance company by party A 500 and party B 510. Generally, the consolidated accident reports transmitted to their insurance companies differ with respect the added evidence provided in fields 592 and 590, respectively for Party A and Party B.

The foregoing illustrations and descriptions merely illustrate specific embodiments of the method of the present invention. However, these specific examples are not meant to limit the scope of the invention in any way as persons of ordinary skill in the art will appreciate that the scope of the described invention encompasses numerous embodiments, which are likewise intended to be encompassed by the claims.

The present invention can be realized in hardware, software, or a combination of hardware and software. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded into a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus, the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to affect one or more functions of this invention. Furthermore, the present invention may be implemented as a program storage device readable by machine, tangibly embodying a program of instructions executable by the machine to perform method steps for causing one or more functions of this invention.

What is claimed is:

1. A computer implemented method for preparing and filing a consolidated electronic accident report from a scene of a vehicular accident, wherein the consolidated accident report is jointly prepared by one or more parties to the accident, the method comprising:
providing one or more digital accident report forms to one or more parties to a vehicular accident wherein each of the one or more parties enters their respective personal information, vehicle information, encrypted signature, user authentication certificate, and optionally, diagrams and/or text relating to the accident;
exchanging the completed digital accident report forms via a wireless communication between opposing parties, and each party either positively acknowledging the opposing party's information or rejecting said information by entering into said form an indication of said acknowledging or said rejecting;
entering each party's global signature to the opposing party's completed digital form; and
generating a consolidated accident report comprising one or more digital accident report forms filled in by each opposing party;
and transmitting the consolidated accident report to an interested third party's server device via a wireless communication,
wherein the wireless communication is transmitted via a handheld wireless communication device or an on-board vehicle wireless communication device.

2. The method of claim 1, wherein entering the encrypted signature comprises preparing a message digest of all personal and vehicle information that each had added to their respective form, and encrypting said message digest with the respective party's private key.

3. The method of claim 2, wherein said interested third party is an insurance company of each respective party, said parties validating each party's identity certificate by contacting one or more certificate authorities.

4. The method of claim 1, comprising one or more of the opposing parties rejecting the opposing party's accident report form, the rejecting comprising modifying the opposing party's digital form.

5. The method of claim 4, the rejecting comprises adding, to said digital form, one or more of a rejection code, checking an appropriate checkbox, or providing a narrative basis for said rejecting.

6. The method of claim 1, said digital form enabling the first and/or second party to enter additional information relevant to the vehicular accident.

7. The method of claim 1, said digital form enabling the first and/or second party entering evidence relevant to the vehicular accident obtained by a witness to said accident.

8. A computer program product for securely providing at least one interested third party with a consolidated accident report, the computer program product comprising a computer usable medium having computer usable program code embodied therewith, the computer usable program code comprising:
computer usable program code configured for providing one or more digital accident report forms to one or more parties to a vehicular accident wherein each of the one or more parties enters into the one or more digital accident report forms their respective personal information, vehicle information, encrypted signature, user certificate, and optionally, diagrams and/or text relating to the accident
computer usable program code configured for exchanging the completed digital accident report forms via a wireless communication between opposing parties, and each party either positively acknowledging the opposing party's information or rejecting said information by entering into said form an indication of said acknowledging or said rejecting;
a computer usable program code configured for entering each party's global signature to the opposing party's completed digital form;
a computer usable program code configured for generating a consolidated accident report comprising one or more digital accident report forms filled in by each opposing party; and,
a computer usable program code configured for transmitting the consolidated accident report to an interested third party's server device via a wireless communication,
wherein the wireless communication is transmitted via a handheld wireless communication device or an on-board vehicle wireless communication device.

9. The computer program product of claim 8, wherein the computer usable code is configured for downloading the vehicle-specific information directly from a vehicle computer system.

10. The computer program product of claim 8, further comprising computer usable code configured for entering information into said accident forms, wherein the information comprises diagrams, drawings, photographs, audio or video recordings.

11. The computer program product of claim 10, wherein the information is provided by a third party witness.
